(19) United States
(12) Patent Application Publication
(10) Pub. No.: US 2024/0042543 A1
(43) Pub. Date: Feb. 8, 2024

(54) METHOD AND MACHINE FOR MANUFACTURING A HOLLOW ITEM MADE OF GLASS

(71) Applicant: ARC FRANCE, Arques (FR)

(72) Inventors: Didier DERAEDT, Arques (FR); Christophe DESGARDIN, Arques (FR); Eric PIECZYRAK, Arques (FR)

(73) Assignee: ARC FRANCE, Arques (FR)

(21) Appl. No.: 18/267,394

(22) PCT Filed: Dec. 15, 2021
(86) PCT No.: PCT/FR2021/052345

§ 371 Date: Jun. 14, 2023

(30) Foreign Application Priority Data
Dec. 17, 2020 (FR) 2013574

(51) Int. Cl. B23K 26/00; B23K 26/0622; B23K 26/08; B23K 26/402; C03B 33/06; C03B 33/02

(52) U.S. Cl. CPC B23K 26/0006; B23K 26/0624; B23K 26/0823; B23K 26/402; C03B 33/06; C03B 33/0222; B23K 2103/54

(57) ABSTRACT

Method for manufacturing a hollow item made of glass, involving receiving a glass item associated with a moil (cap) at a temperature in excess of 100° C., setting the glass item in motion in a direction of conveying and in rotation on itself about an axis of the glass item, moving mobile equipment at a substantially constant distance from the glass item, identifying a relative position of the mobile equipment with respect to an edge of the glass item, regulating the distance between the mobile equipment and an edge of the glass item as the glass item is rotating and as the mobile equipment and the glass item are jointly moving along, firing a laser beam from optics supported by the mobile equipment toward said edge of the glass item in order to make holes and to part the glass item from the moil.

### FIELD OF THE INVENTION

The invention relates to the field of manufacturing glass containers for liquids, and more particularly glassware items.

### BACKGROUND

In a known way, a hollow glass item or rim, in particular a parison of stemmed glass or gob, leaves a machine while hot, which gives it its shape. The glass item has a moil above the concavity for handling it. The moil is removed by heating, stretching and then cutting by heat shock. The glass item is then reheated to relax the residual stresses in the glass. The quality of the cut edge is coarse. The applicant knows a first alternative consisting in cutting the glass while cold using a diamond disc and a diamond coated grinding wheel. A second alternative is to cut the glass cold using a high-power CO₂ laser beam performing glass cutting-off. Cutting-off leaves defects on the cut surface, in particular flaking. These defects are removed by machining with a diamond disc. The rim is then chamfered and then fire polished with flame. In both cases, the result is theoretically defect-free, but the productivity is very low. The applicant considers that hot cutting does not enable the desired quality to be obtained because of the presence of a cutting bead and that cold cutting is very difficult to master because it includes numerous steps (cutting-off, flatting, beveling) which are sources of adjustment problems and therefore of production quality stability.

The applicant has sought to cut the moil while reducing energy consumption, in particular carbon-emitting energy, and water consumption, avoiding waste production, while ensuring a high cutting rate.

### SUMMARY

The applicant has developed a method for manufacturing a hollow item made of glass, comprising receiving a glass item associated with a moil at a temperature above 100° C., setting the glass item in motion in a conveying direction and in rotation on itself about an axis of said glass item, moving a mobile equipment at a substantially constant distance from said glass item, identifying a relative position of the mobile equipment with respect to an edge of said glass item, regulating the distance between the mobile equipment and an edge of said glass item as said glass item is rotating and the mobile equipment and said glass item are jointly moving, firing a laser beam from optics supported by the mobile equipment towards said edge of said glass item to generate holes and separating the moil from the glass item. Thus, high quality hot cutting of the glass is made possible, thereby saving space and reducing energy consumption. The method avoids the use of water and expensive, dust-generating diamond tools.

In one embodiment, the temperature of the glass item and the receiving moil is above 250° C., or even 500° C.

In one embodiment, a tiltable portion of the mobile equipment is tilted so that the laser beam is perpendicular to the zone of said glass item receiving said laser beam. Glass items of various shapes can be treated, in particular with parison ends tilted with respect to the axis of said glass item.

In one embodiment, firing the laser beam has a power of between 0.1 and 1 mJ, in particular 0.25 or 0.5 or 1 mJ per firing. For thick glass items, the power per shot can be increased depending on the availability of adapted laser sources. Higher power enables thicker glass to be cut. High power allows a high distance between the laser optics supported by the mobile equipment and the glass item, making it possible to treat glass items at high temperatures.

In one embodiment, the laser beam is fired at a frequency greater than 50 kHz, for example 200 kHz.

In one embodiment, the wavelength of the laser beam is 976, 1015, 1030 or 1064 nm; these wavelengths may be divided by 2, 3 or 4.

In one embodiment, the pulse duration of the laser firing is between 10-15 and 10-12 s.

In one embodiment, each laser beam firing comprises at least one unit pulse with a duration of between 5 and 12 ps.

In one embodiment, the rotational speed of said glass item is greater than 50 revolutions per minute, preferably 150 revolutions per minute, more preferably 250 revolutions per minute. Said rotational speed is with respect to a central axis of said glass item.

In one embodiment, the translation speed of said glass item is constant or variable. The translation of said glass item is substantially conserved with respect to the translation of a glass item within a conventional cutting production line.

In one embodiment, the mobile equipment is laterally moved to accompany the glass item and, optionally, rearwardly to move on to the next rim in a production line. The movement of the glass item is in translation.

In another embodiment, the rim is supported by a rotating turret in a production line and the mobile equipment accompanies said rim and then moves on to the next rim. The movement of the glass item may be along an arc of a circle.

In one embodiment, a machine for manufacturing a hollow item made of glass comprises a member for conveying in a conveying direction and in rotation on itself about an axis of said glass item associated with a moil at a temperature above 100° C., a mobile equipment capable of moving at a substantially constant distance from said glass item, a member for measuring a relative position of the mobile equipment with respect to an edge of said glass item, a member for regulating the distance between the mobile equipment and an edge of said glass item as said glass item is rotating and the mobile equipment and said glass item are jointly moving, and a laser generator comprising optics supported by the mobile equipment and capable of emitting a laser beam towards said edge of said glass item to generate holes and a member for recovering the moil once separated from the glass item.

In one embodiment, the laser generator comprises a laser source, in particular a stationary laser source, emitting towards said optics.

In one embodiment, said optics comprises a Bessel-type system.

In one embodiment, the laser source is a YAG or Excimer type laser.

In one embodiment, the machine comprises an actuator for moving the mobile equipment in translation parallel to the translation of said glass item and an actuator for moving the mobile equipment in translation perpendicular to the translation of said glass item, controlled by the regulation member.

In one embodiment, the conveying member comprises a chain supporting drums moving the item in translation and in rotation.

In one embodiment, the member for measuring a relative position of the mobile equipment with respect to an edge of said glass item comprises a matrix camera.

In one embodiment, the regulation member comprises a motor-driven shaft controlled as a function of the output of the measurement member.

### BRIEF DESCRIPTION OF THE DRAWINGS

Further characteristics and advantages of the invention will be set out in detail in the following description, made with reference to the appended drawings, in which:

FIG. 1 is a block diagram of the method according to one aspect of the invention, and

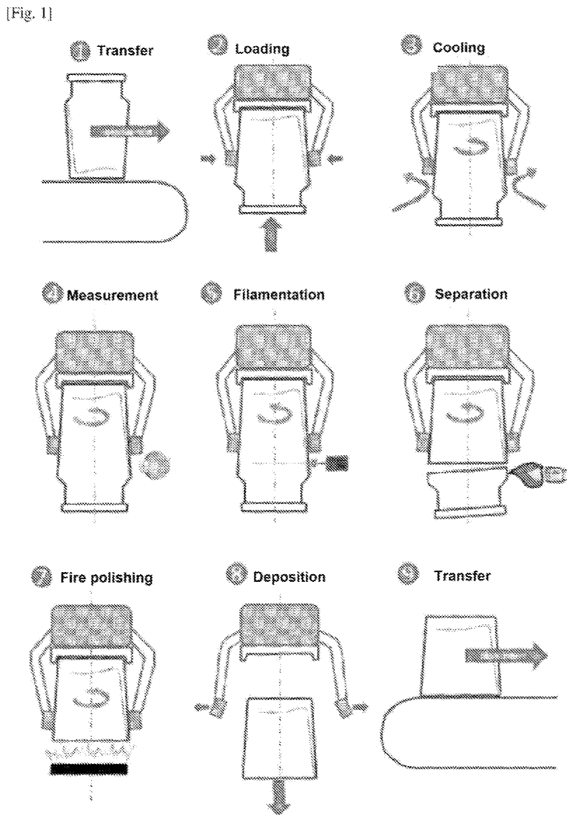

FIG. 2 is a schematic view of beam focusing.

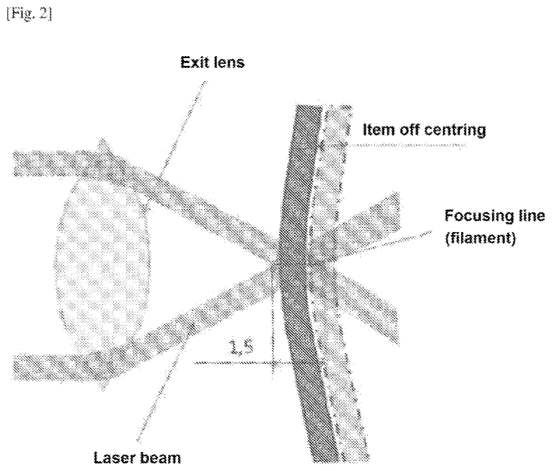

The appended drawings contain, for the most part, elements of certainty. They may therefore serve not only to improve understanding of the present invention, but also to contribute to its definition, where appropriate.

### DETAILED DESCRIPTION OF THE PREFERRED EMBODIMENTS

In general, CO₂ laser cutting on low-temperature glass generally requires heat shock, grinding under water spray, slitting, beveling, flame softening and washing steps. The CO₂ laser has a wavelength that does not pass through glass. This method is long, generates waste, consumes energy and water and requires cumbersome machines.

In parallel, document US2018/062342 describes a treatment method using a laser focused along a line having length L with an intensity varying by less than 40% along the length L of the line.

Document US2018/0257710 relates to a cutting method implementing two different laser beams.

Document US2018/0134606 relates to a method for laser cutting of a glass transparent to said laser by generating plasma by means of ultrashort pulses. The laser is a 1064 nm YAG. The repetition frequency is 10 to 120 kHz. The filament damage spacing is between 4 and 10.10⁻⁶ m. Pulse duration is less than 100 ps. The pulse energy is greater than 0.2 mJ. The laser source is operated at a power of between 40 and 100 W.

According to one aspect of the invention, the machine comprises a member for measuring ovalization of the item. Said measurement member is disposed on the upstream side within the machine. Said measurement member comprises at least one photoelectric cell, or an array of photoelectric cells.

The output of the photoelectric cell providing a position encoding is transmitted to an automaton driving a support for the optical head. The laser axis is positioned over the zone of the glass item to be treated.

Geometric defects of the items are taken into account to ensure that the glass is treated in a single pass. The optical head support is servo controlled from a given average position and corrected in real time. An ovalization measurement system measures a distance as the rotating items pass and corrects position of the focal point over the entire periphery of the items.

A manifest, clean and crisp separation is then obtained when the thickness of the item is no greater than the filament. The length of the filament is greater than 1 mm. Preferably, the thickness of the item does not exceed 1.5 mm minus tracking deviations of more or less 15/100 of one mm. According to one alternative, a rounded edge can be obtained directly by a laser with an astigmatic type lens generating a cracking line having a curved shape.

Hot separation can be carried out with a burner which causes expansion around the entire periphery of the item, then ensures dissociation between parison and moil. On hot items leaving the primary forming machine, separation is very difficult because the item is subject to stresses resulting from contact between the glass and the different forming materials and in particular contact with the molds. A ring of flames can then be used, which almost instantaneously generates a stress over the entire rim of the item and provides annular separation guide. At the moment of separation, stresses released will eject the part to be removed, thus guaranteeing a very clean-cut surface quality.

Fire polishing that follows separation locally remelts the surface of the glass in order to decrease roughness. Fire polishing avoids deformation of the rim and the creation of a bead with a diameter greater than the thickness, while ensuring formation of a slight radius in place of the sharp edges generated previously. Fire polishing can be carried out with the aid of an Air/Gas or Oxygas burner, by radiation or by using a CO₂ laser.

In this way, the item enters the laser treatment zone at a high temperature, is filamented at a pitch adapted by adjusting the rotational speed and laser firing frequency according to the diameter and thickness of the glass, then the parison and moil are separated using a circular burner, and the edge of the parison or rim of the item is fire polished.

The measurement system carries out sampling of distance measurements as the rotating item passes, thus making it possible to treat ovalization and to be able to position the focal beam at the center of the thickness of the glass over the entire periphery of the item in the next cycle. For a quality cut, several parameters need to be taken into account:
laser beam alignment along the entire optical path;
vibrations
output annular beam;
ovalization measurement and profile tracking;
tracking angle;
power, pitch and frequency parameters adapted to the different types of items.

The laser source is stationary to avoid shocks. The laser beam from the laser source is directed to the item treatment zone by a set of mirrors. The mirrors are precisely aligned. A misalignment of the axes would cause a defect on the next axis which would also multiply it by its displacement and so on up to the exit lens.

The laser beam output from the laser source is deflected until it reaches the exit lens through several successive mirrors, each fitted with a safety contact on the opening of its cap. The optical path is protected by a set of rigid slidably mounted tubes that absorb displacements of the movements along three translation axes. The slidably mounted tube connections are sealed against dust by an extendable bellows.

The exit lens comprises two mirrors enabling the nosepiece of the optics to be rotated for normal tracking on the surface of the curvature of the item. The nosepiece is equipped with a two-axis adjustment system for adjusting and ensuring homogeneity of the Bessel-type annular beam on which the uniformity of the laser energy distribution depends.

Variations in positioning and shape of the items, in particular ovalization, mean that this line has to be positioned and recentered at the core of the glass so that the thickness of the wall of the object is correctly treated.

To ensure correct treatment of the glass in a single pass, the translation axis is slave controlled from a given average position and is corrected in real time to adjust to geometric defects of the item.

A first plate movable along the part tracking axis is used to accompany cross-section changes as the items pass. The movement of the movable plate is motor-driven. The trajectory of the movable plate is controlled by the control automaton.

A second plate, movable along the ovalization axis perpendicular to the tracking axis, keeps a constant distance between the wall of the rotating item and the exit lens.

The treatment time for an item depends on the rotational speed of the item, between 50 and 500 rpm. Processing is carried out over one revolution. The connection between the start and end of the filamentation is as proper as possible. Preferably, the vertical deviation is around 0.01 mm and less than 0.02 mm.

Fire polishing can be carried out by linear oxy-gas burners. Linear burners are installed at the periphery of the machine. The burners treat the rim, regardless of its ovalization or thickness variation, in very short times.

The optimum cycle today is:
Loading
Cooling
Rim measurement
Laser filamentation
Separation
Fire polishing
Unloading.

1. A method for manufacturing a hollow item made of glass, the method comprising:
receiving a glass item associated with a moil at a temperature above 100° C.,
setting the glass item in motion in a conveying direction and in rotation on itself about an axis of said glass item,
moving a mobile equipment at a substantially constant distance from said glass item,
identifying a relative position of the mobile equipment with respect to an edge of said glass item,
regulating the distance between the mobile equipment and an edge of said glass item as said glass item is rotating and the mobile equipment and said glass item are jointly moving, and
firing a laser beam from an optics supported by the mobile equipment towards said edge of said glass item to generate holes and separating the moil from the glass item.

2. The method of claim 1, wherein a tiltable portion of the movable equipment is tilted so that the laser beam is perpendicular to a zone of said glass item receiving said laser beam.

3. The method according to claim 1, wherein the laser beam has a power of between 0.1 and 1 mJ.

4. The method according to claim 1, wherein the laser beam has a frequency greater than 50 kHz.

5. The method according to claim 1, wherein a pulse duration of laser firing is between 10⁻¹⁵ and 10⁻¹² s.

6. The method according to claim 1, wherein the rotational speed of said glass item is greater than 50 revolutions per minute.

7. The method according to claim 1, wherein the mobile equipment is moved laterally to accompany the glass item and to move on to a next rim in a production line.

8. A machine for manufacturing a hollow item made of glass, the machine comprising:
a member for conveying along a conveying direction and in rotation on itself about an axis of said glass item associated with a moil having a temperature greater than 100° C.,
a mobile equipment capable of moving at a substantially constant distance from said glass item,
a member for measuring a relative position of the mobile equipment with respect to an edge of said glass item,
a member for regulating the distance between the mobile equipment and an edge of said glass item as said glass item is rotating and the mobile equipment and said glass item are jointly moving,
a laser generator comprising optics supported by the mobile equipment and capable of emitting a laser beam towards said edge of said glass item to generate holes and
a member for recovering the moil once separated from the glass item.

9. The machine according to claim 8, wherein the laser generator further comprises a stationary laser source emitting towards said optics.

10. The machine according to claim 9, further comprising an actuator for moving the mobile equipment in translation parallel to a translation of said glass item and an actuator for moving the mobile equipment in translation perpendicular to the translation of said glass item, controlled by the regulation member.
